(19) United States
(12) Patent Application Publication
(10) Pub. No.: US 2026/0245811 A1
(43) Pub. Date: Aug. 20, 2026

(54) KEYBOARD KEY STRUCTURE

(71) Applicant: SALCOMP (SHENZHEN) CO., LTD., Shenzhen (CN)

(72) Inventors: Tzyy-Shinn HUANG, Taipei City (TW); Cheng-Huei HO, Taipei City (TW); Hsu-Pin CHIEN, Taipei City (TW)

(73) Assignee: SALCOMP (SHENZHEN) CO., LTD., Shenzhen (CN)

(21) Appl. No.: 19/091,110

(22) Filed: Mar. 26, 2025

(30) Foreign Application Priority Data
Feb. 14, 2025 (TW) 114201549

(51) Int. Cl. H01H 13/02; H01H 13/14; H01H 13/70

(52) U.S. Cl. CPC H01H 13/023; H01H 13/14; H01H 13/70

(57) ABSTRACT

A keyboard key structure includes a keyboard key substructure and an electronic ink display module. The electronic ink display module is assembled to the keyboard key substructure. The electronic ink display module includes a first flexible printed circuit board, a timing control integrated circuit, a near field communication antenna, and an electronic ink display panel. The timing control integrated circuit is sandwiched between the first flexible printed circuit board which is bent. The near field communication antenna and the electronic ink display panel are arranged on the first flexible printed circuit board. The first flexible printed circuit board, the timing control integrated circuit, the near field communication antenna, and the electronic ink display panel are electrically connected to each other.

### CROSS-REFERENCE TO RELATED APPLICATION

This application claims benefit of priority to Taiwanese Patent Application No. 114201549 filed Feb. 14, 2025, the entire contents of which are incorporated herein by reference.

### BACKGROUND OF THE DISCLOSURE

### Technical Field

The present disclosure relates to a key structure, and especially relates to a keyboard key structure.

### Description of Related Art

The keyboard is an indispensable apparatus for using a computer or a notebook computer. The keyboard includes a plurality of keyboard keys. A related art keyboard key includes a related art electronic ink display module to change the texts displayed on the related art keyboard key, which is very convenient. However, the structure of the related art keyboard key is very complex, and this problem needs to be solved urgently.

### SUMMARY OF THE INVENTION

In order to solve the above-mentioned problems, an object of the present disclosure is to provide a keyboard key structure.

In order to achieve the object of the present disclosure mentioned above, the keyboard key structure of the present disclosure includes a keyboard key substructure and an electronic ink display module. The electronic ink display module is assembled to the keyboard key substructure. Moreover, the electronic ink display module includes a first flexible printed circuit board, a timing control integrated circuit, a near field communication antenna, and an electronic ink display panel. The timing control integrated circuit is sandwiched between the first flexible printed circuit board which is bent. The timing control integrated circuit is electrically connected to the first flexible printed circuit board. The near field communication antenna is arranged on the first flexible printed circuit board. The near field communication antenna is arranged on the first flexible printed circuit board. The near field communication antenna is electrically connected to the first flexible printed circuit board and the timing control integrated circuit. The electronic ink display panel is arranged on the first flexible printed circuit board. The electronic ink display panel is electrically connected to the first flexible printed circuit board, the timing control integrated circuit, and the near field communication antenna.

Moreover, in an embodiment of the keyboard key structure of the present disclosure mentioned above, the keyboard key substructure includes a key cap and a key lower substructure. The electronic ink display module is assembled to the key cap. The key cap is assembled to the key lower substructure. The key lower substructure includes a lower through area.

Moreover, in an embodiment of the keyboard key structure of the present disclosure mentioned above, the key lower substructure and the electronic ink display module are arranged on a horizontal plane of the key cap.

Moreover, in an embodiment of the keyboard key structure of the present disclosure mentioned above, the key lower substructure is arranged on a horizontal plane of the key cap. The electronic ink display module is arranged in a groove of the key cap adjacent to the horizontal plane.

Moreover, in an embodiment of the keyboard key structure of the present disclosure mentioned above, the key lower substructure is arranged on a horizontal plane of the key cap. The electronic ink display module is arranged in an upper through area of the key cap adjacent to the horizontal plane.

Moreover, in an embodiment of the keyboard key structure of the present disclosure mentioned above, the key lower substructure further includes a rubber dome and a scissor lift substructure. The rubber dome and the scissor lift substructure are arranged on a horizontal plane of the key cap.

Moreover, in an embodiment of the keyboard key structure of the present disclosure mentioned above, the key lower substructure further includes a bottom sticker. The scissor lift substructure is arranged on the bottom sticker.

Moreover, in an embodiment of the keyboard key structure of the present disclosure mentioned above, the key lower substructure further includes a bracket. The bracket is arranged on the bottom sticker.

Moreover, in an embodiment of the keyboard key structure of the present disclosure mentioned above, the key lower substructure further includes a second flexible printed circuit board and a plurality of light emitting diodes. The second flexible printed circuit board is arranged on the bracket. The light emitting diodes are arranged on the second flexible printed circuit board.

Moreover, in an embodiment of the keyboard key structure of the present disclosure mentioned above, the keyboard key substructure further includes a printing layer. The printing layer is arranged on the key cap. The key lower substructure further includes a membrane and a plurality of receiving holes. The membrane is arranged on the second flexible printed circuit board. The rubber dome is arranged on the membrane. The receiving holes are through the bracket, the second flexible printed circuit board, and the membrane. The scissor lift substructure is arranged on the bottom sticker through the receiving holes. The lower through area is through the bottom sticker, the bracket, the second flexible printed circuit board, and the membrane.

The advantage of the present disclosure is to simplify the keyboard key structure having the electronic ink display module.

Please refer to the detailed descriptions and figures of the present disclosure mentioned below for further understanding technologies, methods, and effects and achieving the predetermined purposes of the present disclosure. Further, the purposes, characteristics, and features of the present disclosure may be more deeply and specifically understood. However, the drawings are provided only for references and descriptions and not intended to limit the scope of the present disclosure.

### BRIEF DESCRIPTION OF THE DRAWINGS

FIG. 1 shows an exploded schematic diagram of the first embodiment of the keyboard key structure of the present disclosure.

FIG. 2 shows an exploded schematic diagram of the electronic ink display module of the present disclosure.

FIG. 3 shows a schematic diagram of the electronic ink display module assembled to the key cap of the first embodiment of the present disclosure.

FIG. 4 shows a cross-sectional view of the first embodiment of the keyboard key structure which is unpressed of the present disclosure.

FIG. 5 shows a cross-sectional view of the first embodiment of the keyboard key structure which is pressed of the present disclosure.

FIG. 6 shows a schematic diagram of the electronic ink display module assembled to the key cap of the second embodiment of the present disclosure.

FIG. 7 shows a cross-sectional view of the second embodiment of the keyboard key structure which is unpressed of the present disclosure.

FIG. 8 shows a cross-sectional view of the second embodiment of the keyboard key structure which is pressed of the present disclosure.

FIG. 9 shows an exploded schematic diagram of the third embodiment of the keyboard key structure of the present disclosure.

FIG. 10 shows a schematic diagram of the electronic ink display module assembled to the key cap of the third embodiment of the present disclosure.

FIG. 11 shows a cross-sectional view of the third embodiment of the keyboard key structure which is unpressed of the present disclosure.

FIG. 12 shows a cross-sectional view of the third embodiment of the keyboard key structure which is pressed of the present disclosure.

FIG. 13 shows a schematic diagram of an application including a plurality of the keyboard key structures of the present disclosure.

### DETAILED DESCRIPTION

In the present disclosure, numerous specific details are provided, to provide a comprehensive understanding of embodiments of the present disclosure. However, those skilled in the art may understand that the present disclosure may be practiced without one or more of these specific details. In other instances, well-known details are not shown or described to avoid obscuring features of the present disclosure. The technical content and the detailed description of the present disclosure are as follows with reference to the figures.

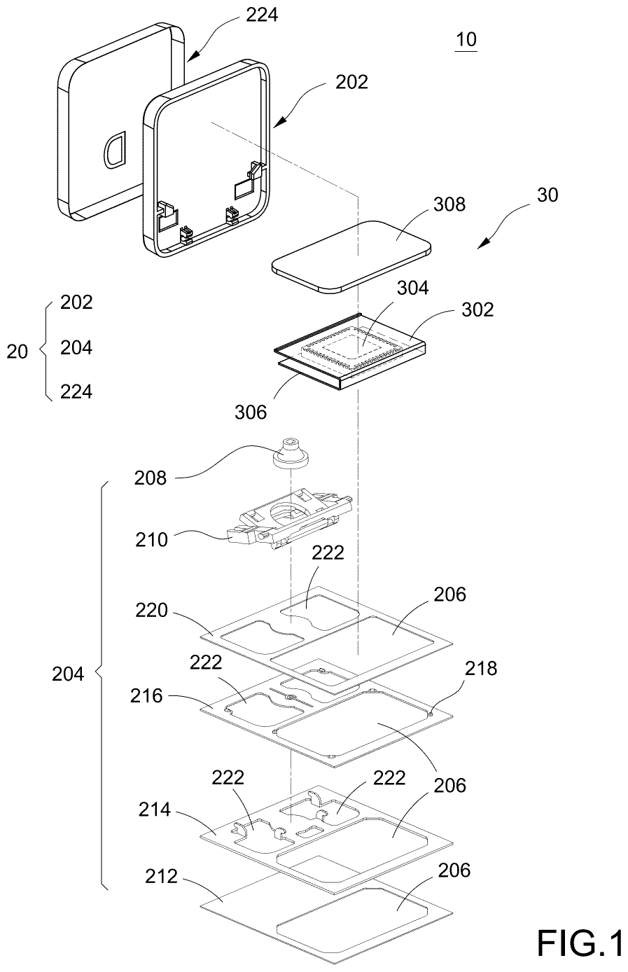

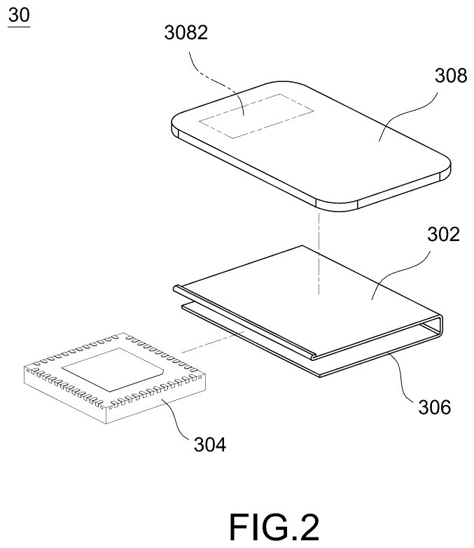

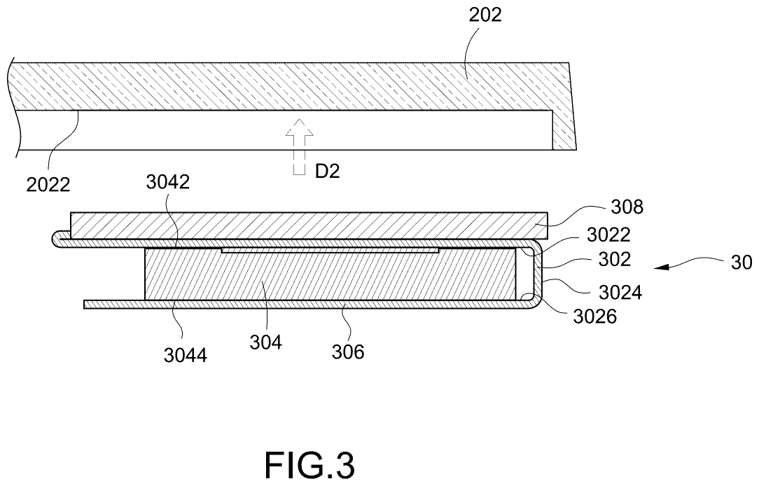

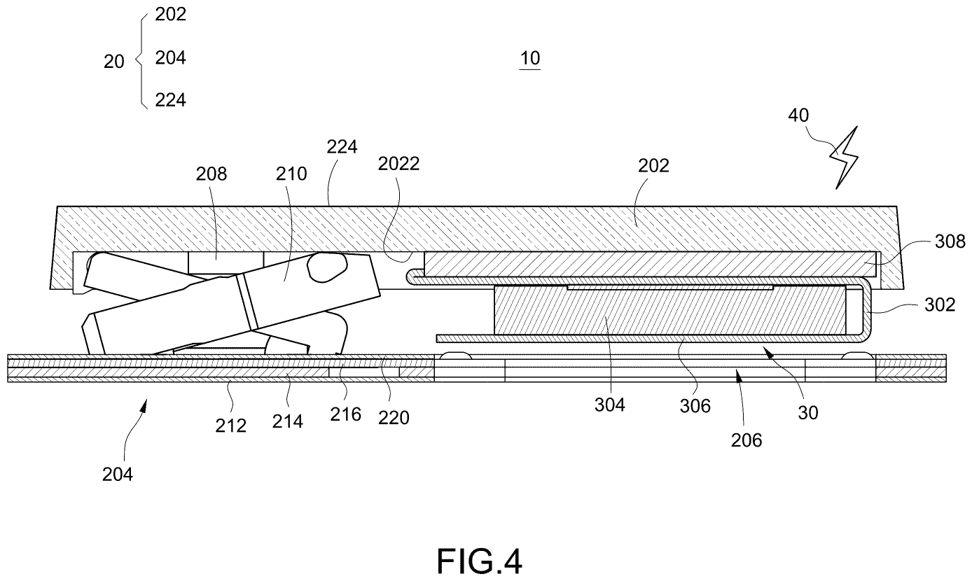

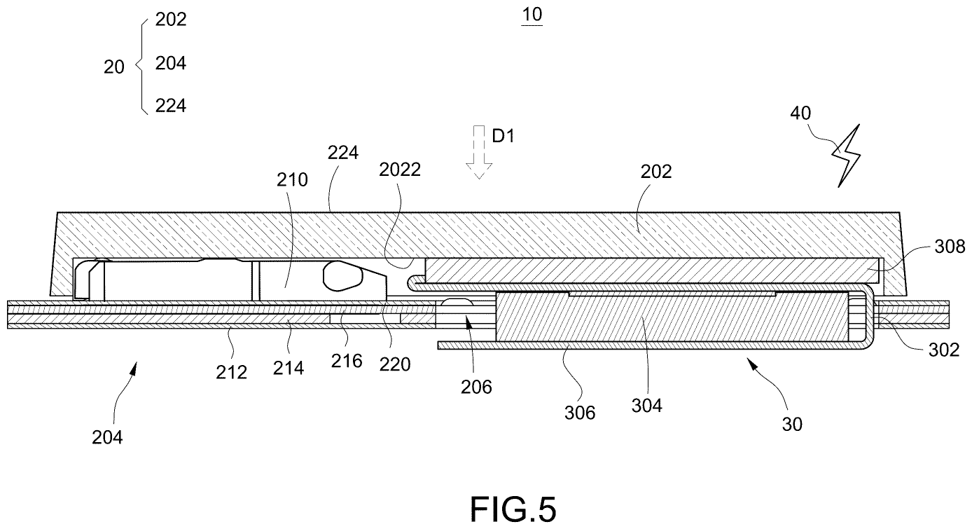

FIG. 1 shows an exploded schematic diagram of the first embodiment of the keyboard key structure 10 of the present disclosure. FIG. 2 shows an exploded schematic diagram of the electronic ink display module 30 of the present disclosure. FIG. 3 shows a schematic diagram of the electronic ink display module 30 assembled to the key cap 202 of the first embodiment of the present disclosure. FIG. 4 shows a cross-sectional view of the first embodiment of the keyboard key structure 10 which is unpressed of the present disclosure. FIG. 5 shows a cross-sectional view of the first embodiment of the keyboard key structure 10 which is pressed of the present disclosure. Please refer to FIG. 1 to FIG. 5 at the same time.

The keyboard key structure 10 of the present disclosure includes a keyboard key substructure 20 and an electronic ink display module 30. The electronic ink display module 30 is assembled to the keyboard key substructure 20.

The electronic ink display module 30 includes a first flexible printed circuit board 302, a timing control integrated circuit 304, a near field communication antenna 306, and an electronic ink display panel 308. The timing control integrated circuit 304 is sandwiched between/by the first flexible printed circuit board 302 which is bent. The near field communication antenna 306 and the electronic ink display panel 308 are arranged on the first flexible printed circuit board 302. The first flexible printed circuit board 302, the timing control integrated circuit 304, the near field communication antenna 306, and the electronic ink display panel 308 are electrically connected to each other. A structure of the electronic ink display module 30 may be called a sandwich structure. The first flexible printed circuit board 302 is a one-piece flexible printed circuit board.

The keyboard key substructure 20 includes a key cap 202, a key lower substructure 204, and a printing layer 224. The electronic ink display module 30 is assembled to the key cap 202. The key cap 202 is assembled to the key lower substructure 204. The printing layer 224 is arranged on the key cap 202. The key lower substructure 204 and the electronic ink display module 30 are arranged on a horizontal plane 2022 of the key cap 202.

The key lower substructure 204 includes a lower through area 206, a rubber dome 208, a scissor lift substructure 210, a bottom sticker 212, a bracket 214, a second flexible printed circuit board 216, a plurality of light emitting diodes 218, a membrane 220, and a plurality of receiving holes 222.

The bracket 214 is arranged on the bottom sticker 212. The second flexible printed circuit board 216 is arranged on the bracket 214 for use by the keyboard key substructure 20 and the light emitting diodes 218. The light-emitting diodes 218 and the membrane 220 are arranged on the second flexible printed circuit board 216. The light-emitting diodes 218 serve as a front light of the electronic ink display panel 308 or a back light of the printing layer 224. The rubber dome 208 is arranged on the membrane 220. The lower through area 206 is through the bottom sticker 212, the bracket 214, the second flexible printed circuit board 216, and the membrane 220.

The receiving holes 222 are through the bracket 214, the second flexible printed circuit board 216, and the membrane 220, so that the scissor lift substructure 210 is arranged on the bottom sticker 212 through the receiving holes 222. The rubber dome 208 and the scissor lift substructure 210 are arranged on the horizontal plane 2022 of the key cap 202. In other words, the rubber dome 208 is arranged between the horizontal plane 2022 of the key cap 202 and the membrane 220. The scissor lift substructure 210 is arranged between the horizontal plane 2022 of the key cap 202 and the bottom sticker 212.

Moreover, when the key cap 202 is pressed (as shown in FIG. 5), the electronic ink display module 30 synchronously moves in a pressing direction D1 to enter or pass through the lower through area 206. For example, when the key cap 202 is pressed (as shown in FIG. 5), a lowermost end of the electronic ink display module 30 is through the lower through area 206 and exceeds the bottom sticker 212 by a distance (for example, 0.4 mm).

Moreover, the first flexible printed circuit board 302 includes a first part 3022, a second part 3024, and a third part 3026 (as shown in FIG. 3). The second part 3024 is arranged between the first part 3022 and the third part 3026. The second part 3024 fails to contact the timing control integrated circuit 304. The first part 3022 contacts a first surface 3042 of the timing control integrated circuit 304 (namely, the first surface 3042 of the timing control integrated circuit 304 is soldered to the first part 3022). The third part 3026 contacts a second surface 3044 of the timing control integrated circuit 304. However, the second surface 3044 of the timing control integrated circuit 304 fails to be soldered to the third part 3026. The first surface 3042 of the timing control integrated circuit 304 is different from the second surface 3044 of the timing control integrated circuit 304. The timing control integrated circuit 304 is sandwiched between the first part 3022 and the third part 3026 (regardless of whether the key cap 202 is pressed; for example, when the key cap 202 is not pressed, or when the key cap 202 is pressed). Moreover, the electronic ink display panel 308 is connected to the first part 3022 and arranged on the first part 3022. The near field communication antenna 306 is arranged on the third part 3026.

Moreover, the timing control integrated circuit 304 is configured to receive a wireless character control signal 40 (as shown in FIG. 4 and FIG. 5) through the near field communication antenna 306 and the first flexible printed circuit board 302 to control a character 3082 (as shown in FIG. 2) displayed on the electronic ink display panel 308 through the first flexible printed circuit board 302.

As shown in FIG. 3, an assembly direction D2 (from bottom to top) of the electronic ink display module 30 assembled to the key cap 202 is opposite to the pressing direction D1 (from top to bottom) as shown in FIG. 5.

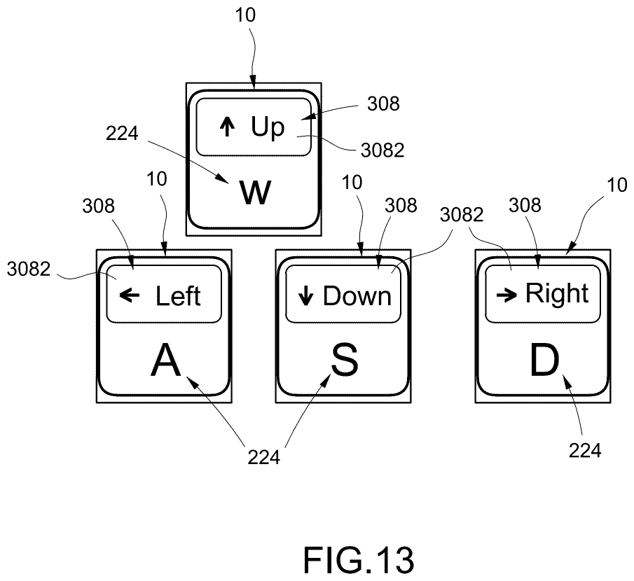

FIG. 13 shows a schematic diagram of an application including a plurality of the keyboard key structures 10 (namely, a part of a keyboard) of the present disclosure. As shown in FIG. 13, the characters 3082 displayed on the electronic ink display panels 308 of the keyboard key structures 10 are ↑Up, ←Left, ↓Down, and →Right respectively. The printing layers 224 of the keyboard key structures 10 respectively display the English letters W, A, S, and D. In other words, the English letter keys W, A, S, and D on the original keyboard are used to control an up direction, a left direction, a down direction, and a right direction respectively. In another embodiment of the present disclosure, the character 3082 is a two-dimensional barcode (QR code). The user may use an appropriate electronic apparatus (for example, a smartphone) to scan the two-dimensional barcode to unlock, for example, a computer or a notebook computer.

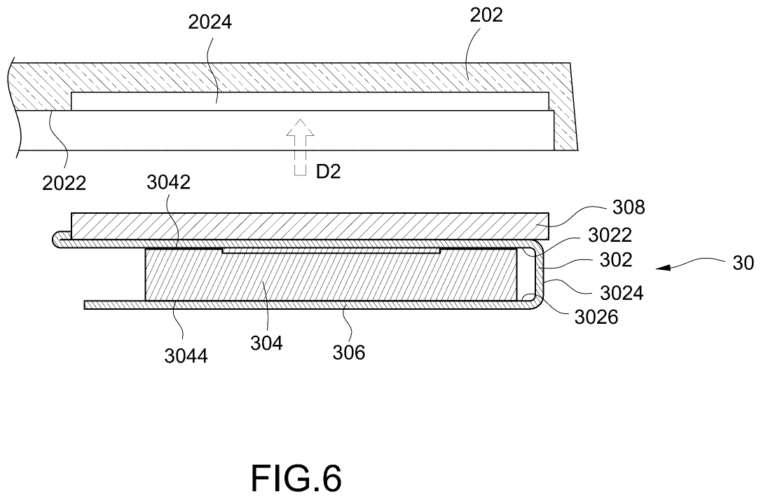

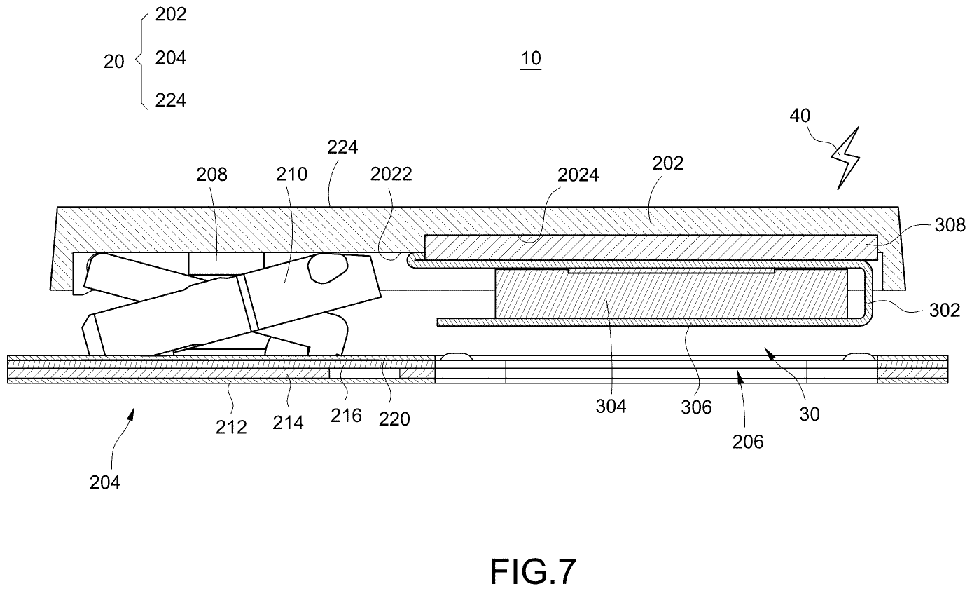

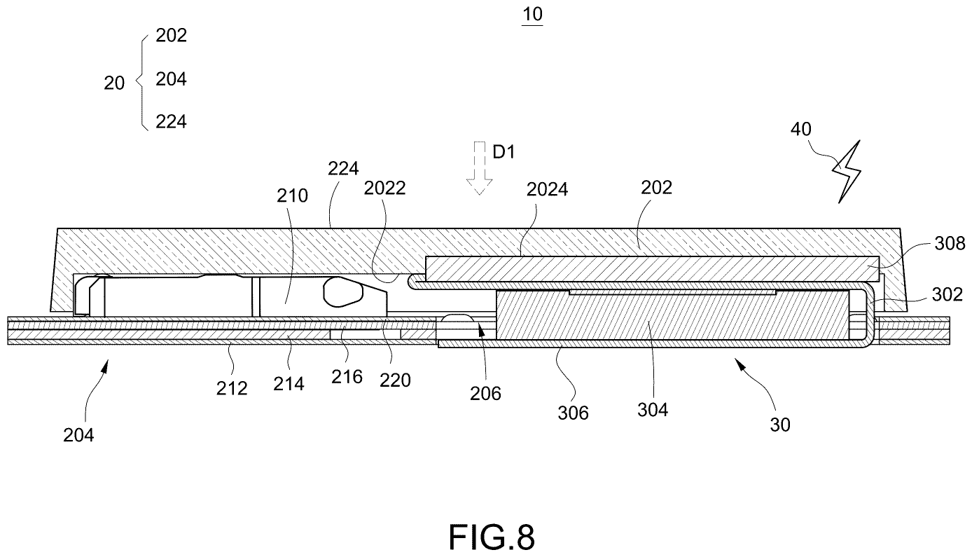

FIG. 6 shows a schematic diagram of the electronic ink display module 30 assembled to the key cap 202 of the second embodiment of the present disclosure. FIG. 7 shows a cross-sectional view of the second embodiment of the keyboard key structure 10 which is unpressed of the present disclosure. FIG. 8 shows a cross-sectional view of the second embodiment of the keyboard key structure 10 which is pressed of the present disclosure. Please refer to FIG. 6 to FIG. 8 at the same time. The content of the second embodiment of the keyboard key structure 10 of the present disclosure is substantially the same as the content of the first embodiment of the keyboard key structure 10 of the present disclosure, and therefore is not described again here.

In the first embodiment of the keyboard key structure 10 of the present disclosure, the key lower substructure 204 and the electronic ink display module 30 are arranged on the horizontal plane 2022 of the key cap 202 (at least as shown in FIG. 4). However, in the second embodiment of the keyboard key structure 10 of the present disclosure, the key lower substructure 204 is arranged on the horizontal plane 2022 of the key cap 202, but the electronic ink display module 30 is arranged in a groove 2024 of the key cap 202 adjacent to the horizontal plane 2022 (at least as shown in FIG. 7), thereby saving more space. The horizontal plane 2022 is different from the groove 2024.

As shown in FIG. 6, an assembly direction D2 (from bottom to top) of the electronic ink display module 30 assembled to the key cap 202 is opposite to the pressing direction D1 (from top to bottom) as shown in FIG. 8.

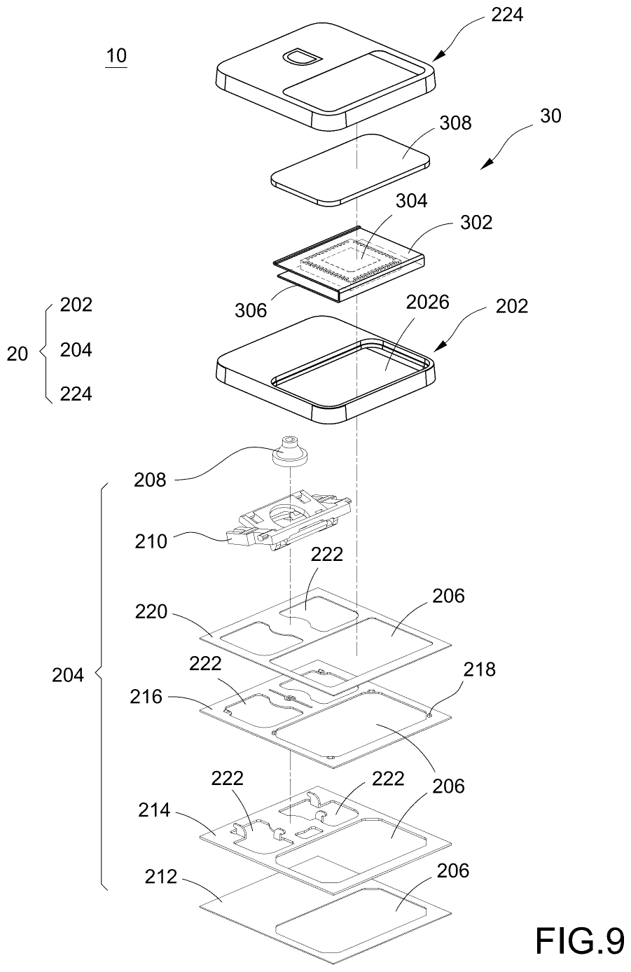

FIG. 9 shows an exploded schematic diagram of the third embodiment of the keyboard key structure 10 of the present disclosure.

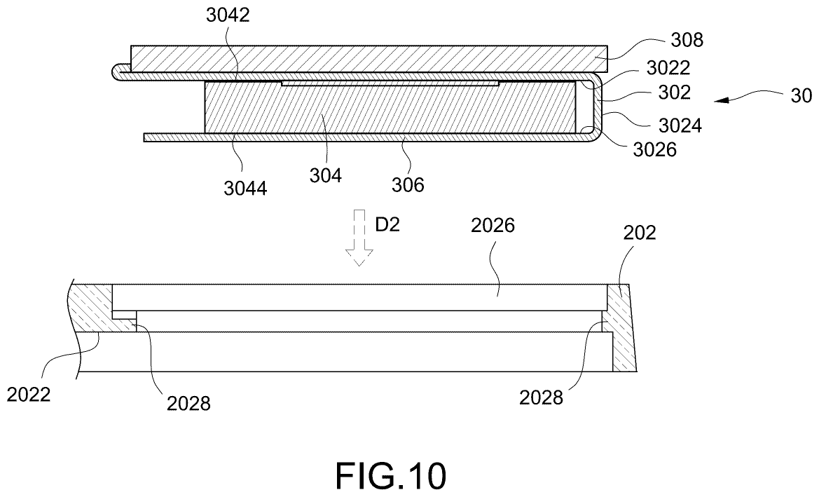

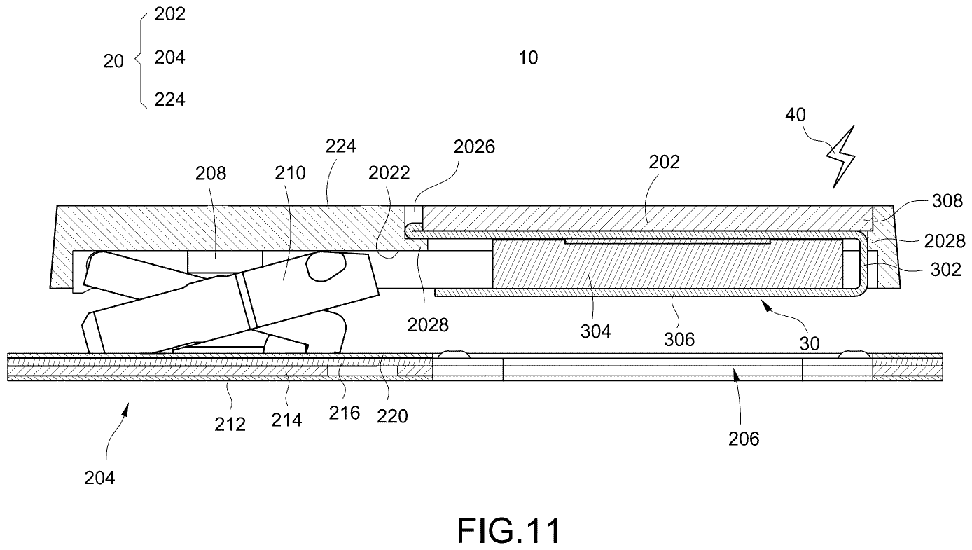

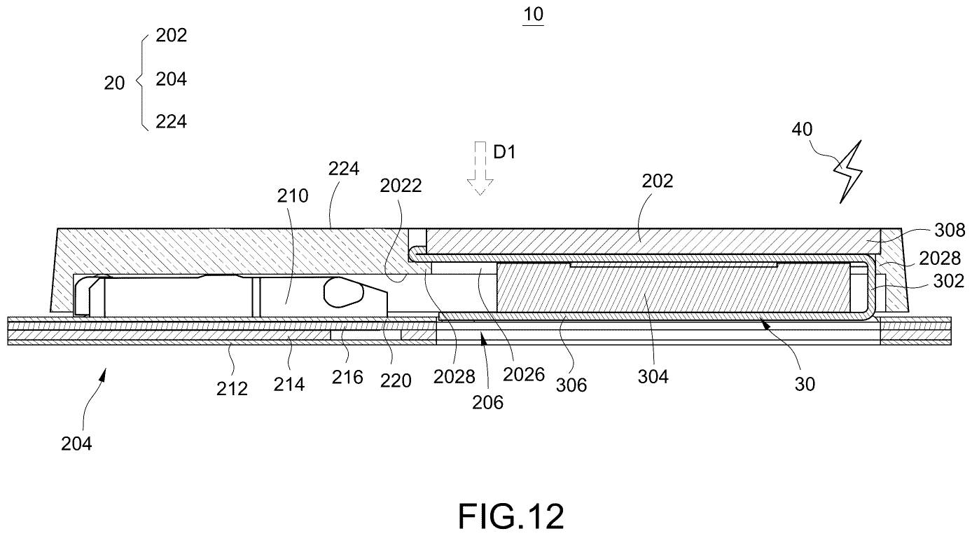

FIG. 10 shows a schematic diagram of the electronic ink display module 30 assembled to the key cap 202 of the third embodiment of the present disclosure. FIG. 11 shows a cross-sectional view of the third embodiment of the keyboard key structure 10 which is unpressed of the present disclosure. FIG. 12 shows a cross-sectional view of the third embodiment of the keyboard key structure 10 which is pressed of the present disclosure. Please refer to FIG. 9 to FIG. 12 at the same time. The content of the third embodiment of the keyboard key structure 10 of the present disclosure is substantially the same as the content of the first embodiment of the keyboard key structure 10 of the present disclosure, and therefore is not described again here.

In the first embodiment of the keyboard key structure 10 of the present disclosure, the key lower substructure 204 and the electronic ink display module 30 are arranged on the horizontal plane 2022 of the key cap 202 (at least as shown in FIG. 4). However, in the third embodiment of the keyboard key structure 10 of the present disclosure, the key lower substructure 204 is arranged on the horizontal plane 2022 of the key cap 202, but the electronic ink display module 30 is arranged in an upper through area 2026 of the key cap 202 adjacent to the horizontal plane 2022 (at least as shown in FIG. 11), thereby saving more space.

As shown in FIG. 10, an assembly direction D2 (from top to bottom) of the electronic ink display module 30 assembled to the key cap 202 is the same as the pressing direction D1 (from top to bottom) as shown in FIG. 12, thereby preventing the electronic ink display module 30 from being separated from the key cap 202 after the electronic ink display module 30 is assembled to the key cap 202.

Moreover, the electronic ink display module 30 is arranged on at least one bump 2028 of the key cap 202 in the upper through area 2026.

For the second embodiment and the third embodiment of the keyboard key structure 10 of the present disclosure, when the key cap 202 is pressed, if the electronic ink display module 30 does not touch the membrane 220, the lower through area 206 may not be provided; or, the depth of the lower through area 206 may be determined based on the overall design requirements. For the first embodiment and the second embodiment of the keyboard key structure 10 of the present disclosure, the key cap 202 is made of transparent materials, allowing the user to see the character 3082 displayed on the electronic ink display panel 308.

The advantage of the present disclosure is to simplify the keyboard key structure having the electronic ink display module.

Although the present disclosure has been described with reference to the embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure.

What is claimed is:

1. A keyboard key structure comprising:
a keyboard key substructure; and
an electronic ink display module, assembled to the keyboard key substructure,
wherein the electronic ink display module comprises:
a first flexible printed circuit board;
a timing control integrated circuit, sandwiched between the first flexible printed circuit board being bent, and electrically connected to the first flexible printed circuit board;
a near field communication antenna, arranged on the first flexible printed circuit board, and electrically connected to the first flexible printed circuit board and the timing control integrated circuit; and
an electronic ink display panel, arranged on the first flexible printed circuit board, and electrically connected to the first flexible printed circuit board, the timing control integrated circuit, and the near field communication antenna.

2. The keyboard key structure of the claim 1, wherein the keyboard key substructure comprises a key cap and a key lower substructure; the electronic ink display module is assembled to the key cap; the key cap is assembled to the key lower substructure; the key lower substructure comprises a lower through area.

3. The keyboard key structure of the claim 2, wherein the key lower substructure and the electronic ink display module are arranged on a horizontal plane of the key cap.

4. The keyboard key structure of the claim 2, wherein the key lower substructure is arranged on a horizontal plane of the key cap; the electronic ink display module is arranged in a groove of the key cap adjacent to the horizontal plane.

5. The keyboard key structure of the claim 2, wherein the key lower substructure is arranged on a horizontal plane of the key cap; the electronic ink display module is arranged in an upper through area of the key cap adjacent to the horizontal plane.

6. The keyboard key structure of the claim 2, wherein the key lower substructure further comprises a rubber dome and a scissor lift substructure; the rubber dome and the scissor lift substructure are arranged on a horizontal plane of the key cap.

7. The keyboard key structure of the claim 6, wherein the key lower substructure further comprises a bottom sticker; the scissor lift substructure is arranged on the bottom sticker.

8. The keyboard key structure of the claim 7, wherein the key lower substructure further comprises a bracket; the bracket is arranged on the bottom sticker.

9. The keyboard key structure of the claim 8, wherein the key lower substructure further comprises a second flexible printed circuit board and a plurality of light emitting diodes; the second flexible printed circuit board is arranged on the bracket; the light emitting diodes are arranged on the second flexible printed circuit board.

10. The keyboard key structure of the claim 9, wherein the keyboard key substructure further comprises a printing layer; the printing layer is arranged on the key cap; the key lower substructure further comprises a membrane and a plurality of receiving holes; the membrane is arranged on the second flexible printed circuit board; the rubber dome is arranged on the membrane; the receiving holes are through the bracket, the second flexible printed circuit board, and the membrane; the scissor lift substructure is arranged on the bottom sticker through the receiving holes; the lower through area is through the bottom sticker, the bracket, the second flexible printed circuit board, and the membrane.
